(19) United States
(12) Patent Application Publication
(10) Pub. No.: US 2005/0021655 A1
(43) Pub. Date: Jan. 27, 2005

(54) System for efficiently acquiring and sharing runtime statistics

(75) Inventors: James Liu, Sunnyvale, CA (US); Chien-Hua Yen, Los Altos, CA (US); Raghavender Pillutla, San Jose, CA (US)

Correspondence Address: BEYER WEAVER & THOMAS LLP, P.O. BOX 778, BERKELEY, CA, 94704-0778, US

(73) Assignee: Sun Microsystems, Inc., Santa Clara, CA (US)

(21) Appl. No.: 10/457,848

(22) Filed: Jun. 9, 2003

(51) Int. Cl. G06F 15/167

(52) U.S. Cl. 709/213

(57) ABSTRACT

Methods and apparatus for sharing data provided by a first application to two or more additional applications (e.g., probes) are disclosed. It is ascertained whether the first application is executing. When it is ascertained that the first application is executing, data produced by the first application is provided to the two or more additional applications if data provided by the first application can be shared by the two or more additional applications. When it is ascertained that the first application is not executing or if data provided by the executing first application cannot be shared by the two or more additional applications, the first application is executed such that data provided by the first application can be provided to the two or more additional applications and the data produced by the first application is distributed to the two or more additional applications.

### CROSS REFERENCE TO RELATED APPLICATIONS

This invention is related to U.S. patent application Ser. No. ______(Attorney Docket No. SUN1P857/P9686), filed on the same day as this patent application, naming Liu et al. as inventors, and entitled “SYSTEMS AND METHODS FOR SOFTWARE PERFORMANCE TUNING.” That application is incorporated herein by reference in its entirety and for all purposes.

This application is also related to U.S. patent application Ser. No. ______(Attorney Docket No. SUN1P859/P9688), filed on the same day as this patent application, naming Liu et al. as inventors, and entitled “METHODS AND APPARATUS FOR ENHANCED STATISTICAL PERFORMANCE.” That application is incorporated herein by reference in its entirety and for all purposes.

### BACKGROUND OF THE INVENTION

1. Field of the Invention

The present invention relates generally to computer software. More particularly, the present invention relates to methods and apparatus for acquiring and sharing runtime data.

2. Description of Related Art

In an object-oriented system, classes are used to encapsulate methods and variables. A class is then instantiated to generate an object, or instance of the particular class. Multiple instances of a single class are often instantiated in order to simultaneously run a particular method in different scenarios. In this manner, the method may be run multiple times in parallel.

The process of assessing the current level of performance of software is often referred to as “software performance tuning.” For instance, software performance tuning may be used to test a software application that is run on the underlying computer system or that is a part of the underlying system (e.g., operating system). The resulting data is then analyzed to ascertain the causes of undesirable performance characteristics, such as the speed with which a particular software application is executed.

In order to implement a performance analysis tool for a running computer system, it is typically necessary to query the application or underlying system (e.g., operating system) to obtain runtime data indicating the level of performance of the corresponding application or underlying system. This data may then be processed to obtain additional performance data. However, it may be desirable to process the obtained data in different ways, and therefore by different processes.

Often, in order to process data generated by the application or underlying computer system, the desired method is called by different processes. As a result, multiple objects are typically instantiated in order to enable the method to be simultaneously called by these processes. Unfortunately, running multiple instances of the same method (e.g., system utility) may be intrusive to the running computer system and decrease the efficiency of system resource utilization. Specifically, the amount of data generated is multiplied by the number of instances of the data capturing method. In addition, the processor speed may be inadequate to run all instances simultaneously without a noticeable effect on system performance. In fact, the underlying hardware may limit the number of processes that may be simultaneously executed. Moreover, the accuracy of the data indicating the level of performance of the application or underlying system may be in question, since the method used to query that performance may have impacted the level of performance.

In view of the above, it would be beneficial if data obtained from a particular method (e.g., system utility) could be shared among multiple running processes.

### SUMMARY

Methods and apparatus for sharing data provided by a first application to two or more additional applications (e.g., probes) are disclosed. This is accomplished, in part, through minimizing the number of times the application is executed (e.g., instantiated). The data is then intercepted and provided to the requesting applications.

In accordance with one aspect of the invention, it is ascertained whether the first application is executing. When it is ascertained that the first application is executing, data produced by the first application is provided to the two or more additional applications if data provided by the first application can be shared by the two or more additional applications. When it is ascertained that the first application is not executing or if data provided by the executing first application cannot be shared by the two or more additional applications, the first application is executed such that data provided by the first application can be provided to the two or more additional applications and the data produced by the first application is distributed to the two or more additional applications.

In accordance with another aspect of the invention, it is determined that the two or more additional applications call the first application For instance, when one of the additional applications is executed, it is determined that the additional application calls the first application. One or more instances of the first application are instantiated and executed, each of the instances of the first application sampling data at a different sampling rate. Data produced by the instances of the first application is then provided to the two or more additional applications such that the sampling rate of an instance of the first application is greater than or equal to a sampling rate requested by the corresponding one of the two or more additional applications that is receiving data from the instance of the first application. In other words, the sampling interval is less than or equal to that requested.

In accordance with one embodiment, when one of the two or more additional applications is executed, a sampling rate requested by the one of the two or more additional applications is determined. It is then determined whether an instance of the first application that is executing has a sampling rate that is greater than or equal to the sampling rate requested by the one of the two or more additional applications. When it is determined that an instance of the first application that is executing has a sampling rate that is greater than or equal to the sampling rate requested by the one or the two or more additional applications, data from the instance of the first application is provided to the one of the two or more additional applications. When it is determined that an instance of the first application that is executing does not have a sampling rate that is greater than or equal to the sampling rate requested by the one of the two or more additional applications, a new instance of the first application is instantiated with a sampling rate that is greater than or equal to the sampling rate requested by the one of the two or more additional applications and data from the new instance of the first application is provided to the one of the two or more additional applications.

### BRIEF DESCRIPTION OF THE DRAWINGS

The invention, together with further advantages thereof, may best be understood by reference to the following description taken in conjunction with the accompanying drawings in which:

FIG. 1 is a block diagram illustrating a system for performing software performance tuning in accordance with various embodiments of the invention.

FIG. 2 is a process flow diagram illustrating a method of performing software performance tuning in accordance with various embodiments of the invention.

FIG. 3 is a screen shot illustrating runtime data that may be generated by a probe in accordance with various embodiments of the invention.

FIG. 4 is a screen shot illustrating graphical user interface for simultaneously executing multiple probes in accordance with various embodiments of the invention.

FIG. 5 is a diagram illustrating a format for submitting probe specifications in accordance with various embodiments of the invention.

FIG. 6 is a process flow diagram illustrating a method of implementing a probe in accordance with various embodiments of the invention.

FIG. 7 is a block diagram illustrating a system for acquiring and sharing runtime statistics in accordance with various embodiments of the invention.

FIG. 8 is a block diagram illustrating a buffer object for managing I/O streams in order to support the acquiring and sharing of runtime statistics in the system of FIG. 7 in accordance with various embodiments of the invention.

FIG. 9 is a diagram illustrating an exemplary hash table used to manage output streams in accordance with various embodiments of the invention.

FIG. 10 is a diagram illustrating an exemplary lookup table used to manage input streams in accordance with various embodiments of the invention.

FIG. 11 is a process flow diagram illustrating a method of acquiring and sharing runtime statistics in accordance with various embodiments of the invention.

FIG. 12 is a diagram illustrating runtime data sampled in accordance with prior art methods.

FIG. 13 is a diagram illustrating runtime data sampled in accordance with various embodiments of the invention.

FIG. 14 is a process flow diagram illustrating a method of sampling data to enhance statistical performance in accordance with various embodiments of the invention.

FIG. 15 is a block diagram illustrating a typical, general-purpose computer system suitable for implementing the present invention.

### DETAILED DESCRIPTION OF THE PREFERRED EMBODIMENTS

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

Various software performance criteria may be analyzed through the use of such a software performance tuning tool. For instance, software characteristics such as speed (e.g., bits/second) may be assessed. Three exemplary types of data may be collected, calculated and/or analyzed by such a software performance tool. First, absolute data such as a cycle count or instruction count may be collected. Second, relative data such as cycle count in the last 5 seconds may be collected. In other words, relative data is absolute data that is relative to other criteria or data, such as time. Third, derived data such as cycle count/instruction count (CPI) may be collected. In other words, derived data is derived from other absolute data. In accordance with various embodiments of the invention, software characteristics may be interactively obtained and assessed.

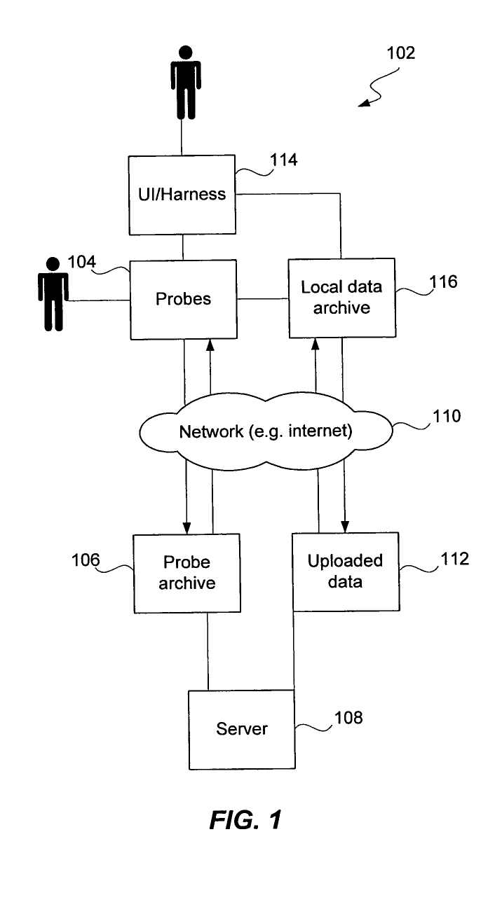

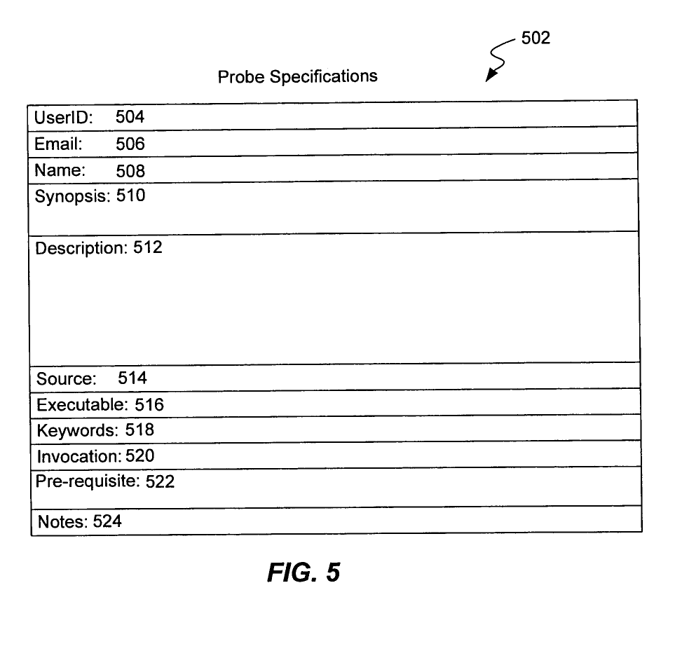

FIG. 1 is a block diagram illustrating a system 102 for performing software performance tuning in accordance with various embodiments of the invention. One or more probes 104 (i.e., applications) are provided which each produce data assessing one or more levels of performance of an application. For instance, the data may include one or more software characteristics such as those described above. The probes 104 may be stored locally and/or in a probe archive 106 on a remotely located server 108 accessible via a network such as the Internet 110. Probes may be manually or automatically downloaded (or updated) from the probe archive 106 as well as uploaded to the probe archive 106. For instance, various individuals may upload a probe to be included in the archive. Each probe that is uploaded is preferably reviewed prior to its inclusion in the probe archive. A set of probe specifications such as those described below with reference to FIG. 5 are preferably uploaded with each probe to enable the probe to be evaluated prior to its inclusion in the probe archive. In addition, it may be desirable to limit access to probes in the probe archive 106 as well as uploaded data 112 to one or more individuals or customers. Thus, a key or password may be used to access probes as well as uploaded data.

In order to run a probe, a graphical user interface 114 (i.e., user harness) is provided. Alternatively, a user may wish to run a probe without using the graphical user interface 114, such as through the use of a command line (e.g., UNIX™ Prompt). One or more probes may be executed sequentially or in parallel. Alternatively, a scheduler may be used to automate the lifecycle of one or more probes. The data generated and intercepted by each of these probes may then be stored in a local data archive 116. This data may be displayed as well as analyzed to assess the application being tested, as well as used to identify one or more additional probes to be executed for further analysis of the System Under Test (SUT). The data may be displayed in a variety of formats, such as a tabular or graph format.

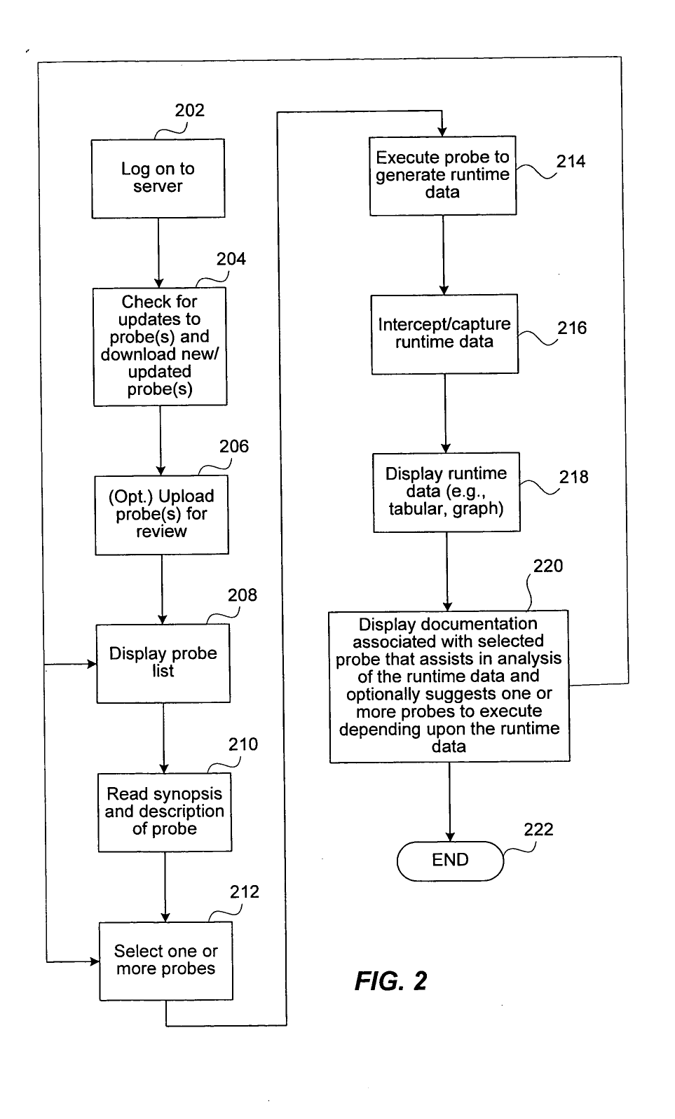

FIG. 2 is a process flow diagram illustrating a method of performing software performance tuning in accordance with various embodiments of the invention. The user first logs onto the server 202 via the Internet at block 202. One or more probes are then downloaded and/or updated at block 204. For instance, there may be new probes that have been added to the probe archive or updated, requiring the new probes or updated probes to be downloaded. In addition, the user may also wish to upload one or more probes for review and inclusion in the probe archive at block 206.

A probe list listing one or more available probes (e.g., available for execution by a particular customer or all customers) is then displayed at block 208 from which the user may select one or more probes to execute. The user may wish to view probe specifications associated with the probe at block 210. For instance, the user may wish to read a synopsis of functions performed by the probe, as well as a detailed description of the probe (e.g., functionality, execution instructions, and/or expected output) at block 210. The user may then select one or more probes to execute at block 212.

In accordance with one embodiment, each probe supports Standard Input (STDIN) and Standard Output (STDOUT) for normal logging functions and diagnostic text, if produced. In addition, error and administration messages are sent to Standard Error (STDERR). In addition, one or more probes are optionally invoked through a single command at the shell command line. No additional commands should be required to be executed other than this single command to generate the probe output. In accordance with various embodiments, a property file that defines the runtime environment of the probe(s) is defined by the user prior to invoking the probe(s).

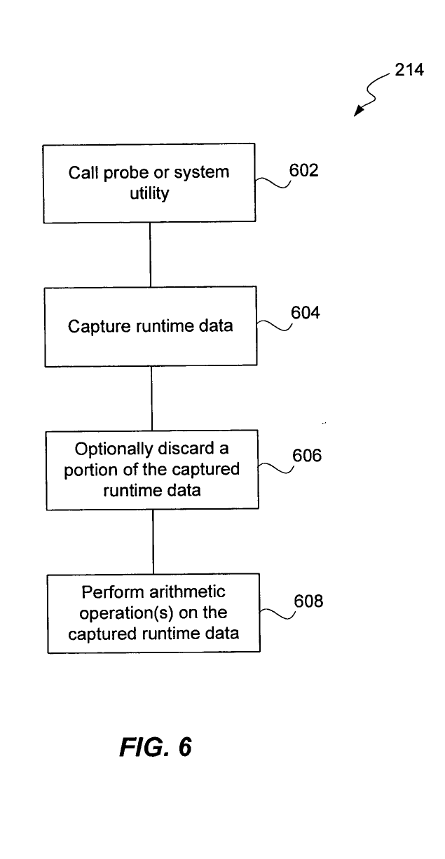

When a probe is executed at block 214, it generates runtime data (e.g., output data). For instance, data may be obtained from a register. The types of data that may be generated and/or calculated by a probe include absolute data, relative data, and derived data. The presentation of the data is in ASCII format. Generally, a probe samples data over a period of time and averaged. This data is intercepted at block 216. The data may be obtained from a log file, which may also include associated diagnostic text. It may be desirable to discard a portion of the data and/or perform one or more arithmetic operations on the data. This may be accomplished, for example, through the use of a Java wrapper, as will be described in further detail below with reference to FIG. 6. The original and/or modified data may then be displayed at block 218. For instance, the data may be displayed in tabular or graphical format. Documentation associated with the selected probe is then displayed at block 220. For instance, the documentation may indicate a manner of interpreting the data assessing one or more levels of performance of the application. As another example, the documentation may suggest one or more probes to execute that can provide additional information to assess one or more levels of performance of the application being tested (e.g., SUT). The documentation may be a single set of documentation associated with the selected probe. Thus, the documentation may provide multiple sets of documentation, where each set of documentation is associated with a different range of values of data produced by the probe. The user may then interpret the appropriate set of documentation as indicated by the output results. For instance, each probe suggested may correspond to a specified range of output data values, which may be different or the same as other probe(s) that are recommended. Alternatively, the documentation that is provided may correspond to a particular range of values of the data produced by the probe. In other words, multiple sets of documentation may be associated with a particular probe from which the appropriate set of documentation is presented depending upon the range of values of data produced by the probe. The documentation may also be incorporated into a rules engine, which will automate the execution of further probes and will not make it mandatory to read the documentation to proceed further. In other words, the rules engine may determine which probe(s) to automatically execute based upon the results of data values produced by the probe.

Once the documentation is provided, the user may select one or more probes to execute to further test the application. For instance, the user may wish to select one or more probes from the probe list as described above at block 208. The user may also wish to select one or more probes that have been recommended in the documentation presented to the user. These probes may be selected from the probe list or, alternatively, they may be executed at block 212 by clicking on a link (e.g., URL) provided in the documentation. The process ends at block 222.

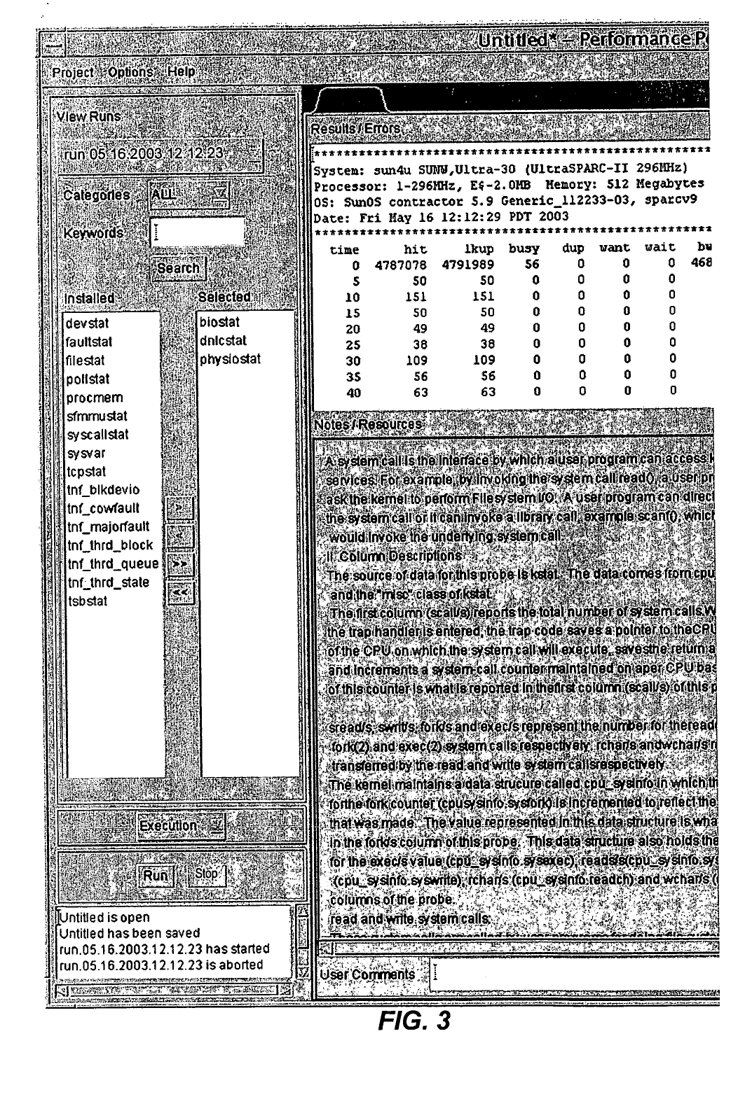

FIG. 3 is a screen shot illustrating runtime data that may be generated by a probe in accordance with various embodiments of the invention. As shown in FIG. 3, a user may specify one or more keywords to search for the appropriate probe(s) to execute. These keywords may, for instance, be used to search the probe specifications for the appropriate probe(s) to execute. Exemplary probe specifications will be described in further detail below with reference to FIG. 5. Installed probes are listed in a probe list, which enables a user to select and de-select probes to execute, which are shown as selected probes. In this example, three different probes, biostat, dnlcstat, and physiostat, are selected. When executed, the results (e.g., runtime data or processed runtime data) is presented. Specifically, the user may select a particular set of results, such as by clicking on the appropriate tab. In this example, the results for the probe, biostat, are displayed. In addition, below the results, a set of documentation is presented that corresponds to the probe, biostat, that has been executed. The documentation includes information describing the data presented in the columns, as well as the source of the data that is presented.

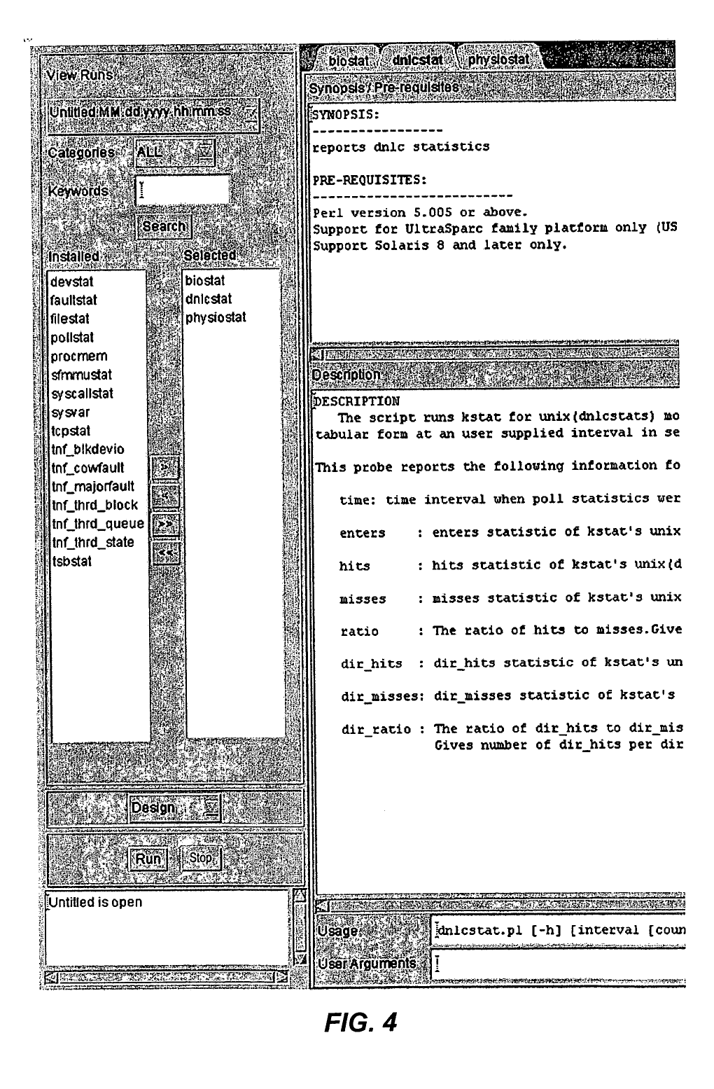

FIG. 4 is a screen shot illustrating graphical user interface for simultaneously executing multiple probes in accordance with various embodiments of the invention. In order to select multiple probes such as those selected in FIG. 3, the user selects one or more probes from those probes that have been installed. Those probes that have been selected are then presented, as shown. Upon selection, the user may view at least a portion of the probe specifications associated with the probe prior to executing the probe. For instance, as shown, the synopsis, pre-requisites, and detailed description may be viewed. The user may then execute or de-select the selected probe(s). Exemplary probe specifications will now be described with reference to FIG. 5.

FIG. 5 is a diagram illustrating a format for submitting probe specifications 502 in accordance with various embodiments of the invention. The probe may be submitted in any language, such as C, Perl, Java™, or Unix™ shell. As described above, an application that is submitted (e.g., uploaded) is preferably submitted with an associated set of probe specifications 502. Any 3^{rd} party tool, system utility or other application can be integrated as a probe. The user submitting the probe is preferably identified in the probe specifications, such as by a userID 504. In addition, contact information for the user such as an email address 506, as well as the name of the user 508 may also be provided. A synopsis 510 and more detailed description 512 of the probe may also be provided. The synopsis 510 is preferably a brief description (e.g., one-line summary) of the probe, such as what data the, probe generates (e.g., what functions the probe performs). The detailed description 512 is preferably a more detailed (e.g., multi-lined description) of the probe. This description 512 may include, for example, what functions the probe performs, what data is generated by the probe, what are the required inputs and outputs, and/or an example illustrating execution of the probe. In addition to the executable code 516, the source code 514 is also preferably submitted. The source file(s) are preferably text files with conventional suffixes corresponding to the type of file. The source file(s) also preferably includes a build script, Makefile, detailed README, INSTALL text files, or the equivalent. One or more keywords 518 associated with the probe, a name, method or command for invoking the probe 520, pre-requisite(s) 522 to executing the probe, and any additional notes 524 are also included in the probe specifications. For instance, pre-requisite(s) 522 may, for example, indicate dependencies of the probe (e.g., source code) on other packages such as Perl 5.x. The pre-requisites 522 may also include information such as global variables, memory requirements, CPU requirements, and/or operating system requirements (e.g., operating system type and version(s)). The keywords 518 may, for instance, include a one-line text list of words delimited by spaces that may be used by a search engine to identify probes. Once the probe and associated specifications are submitted, the probe may be included in the probe archive (stored remotely or locally) or rejected by the reviewer upon review of the specifications and/or associated probe.

Each probe is preferably submitted with an associated set of documentation (not shown). As described above, the set of documentation preferably indicates a manner of interpreting the probe results (e.g., data) indicating one or more levels of performance of the application being tested. Specifically, the documentation may explain the probe results as well as methods of interpretation. In addition, the set of documentation preferably suggests execution of one or more probes that can provide additional information to assess one or more levels of performance of the application being tested.

FIG. 6 is a process flow diagram illustrating a method of implementing (e.g., executing) a probe as shown at block 214 of FIG. 2 in accordance with various embodiments of the invention. A probe may be executed as submitted by a user. However, it may also be desirable to select a portion of the data produced by a probe and/or perform one or more arithmetic operations on the data. Thus, the probe (e.g., application or system utility) is called at block 602. The runtime or output data is then captured at block 604. A Java wrapper may then be used to optionally discard a portion of the captured data at block 606 and/or perform any desired arithmetic operation(s) on the captured data at block 608. For instance, selected data samples may be obtained and averaged over the samples produced by the probe or selected.

It may be desirable for multiple applications (e.g., probes) to call a single application (e.g., probe or system utility). For instance, multiple probes may wish to call the probe or system utility. However, the underlying hardware may limit the number of processes that may execute simultaneously. Thus, methods and apparatus for acquiring and sharing runtime data and/or statistics are disclosed.

In the described embodiments, an object-oriented system is described. For instance, various described embodiments may be implemented in a Java™ based system that will run independent of an operating system. However, this description is merely illustrative, and alternative mechanisms for implementing the disclosed embodiments are contemplated.

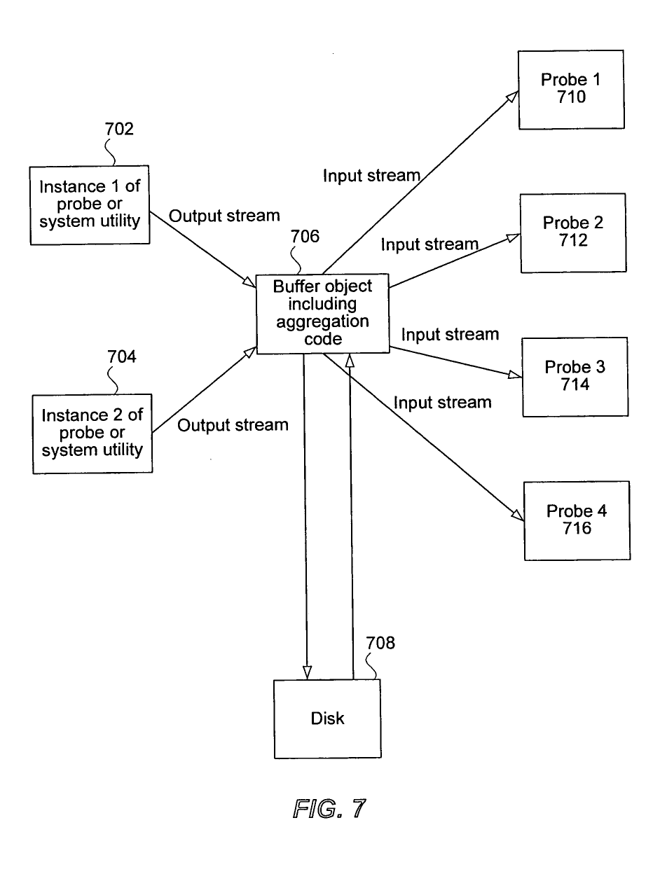

FIG. 7 is a block diagram illustrating a system for acquiring and sharing runtime statistics in accordance with various embodiments of the invention. In an object-oriented system, in order to execute a method, the class including the method is instantiated, producing an instance of the class (i.e., object). Thus, as shown at block 702, a first instance of the application (e.g., probe or system utility) is generated and executed. In order to share the data generated by the application, the data is sampled at the lowest common denominator. In other words, the data is sampled at a rate that is higher than or equal to that requested by the probe that receives the data. As a result, if a new probe requests data from the application that is already executing and that probe requires data at a rate greater than that sampled by the first instance, a new second instance of the class including the application is generated, as shown at block 704. Thus, the instance may be of the same or a different probe or utility.

A mechanism for intercepting, storing and distributing this data to the appropriate requesting probe(s) is provided in the form of a buffer object as shown at block 706. The buffer object includes aggregation code that collects the data, stores the data temporarily and/or to a disk 708. The aggregation code distributes the data at the appropriate sampling rate to the probes 710, 712, 714, and 716 provided in the form of a buffer object as shown at block 706. The buffer object includes aggregation code that collects the data, stores the data temporarily and/or stores the data to a disk 708. The aggregation code obtains the data from one or more instances of the application and distributes the data at the appropriate sampling rate to the probes 710, 712, 714, and 716. An exemplary object will be described in further detail below with reference to FIG. 8.

In accordance with one embodiment, an output stream is associated with each instance of the application and an input stream is associated with each probe requesting data from the application. Specifically, an input stream is created through instantiating an instance of the InputStream class of the java.io package and an output stream is created through instantiating an instance of the OutputStream class of the java.io package. Specifically, an instance of a PipedInputStream and an instance of a PipedOutputStream are generated, which inherit the properties of the InputStream class and OutputStream class, respectively. The piped input and output streams implement the input and output components of a pipe. Pipes are used to channel the output from one program (or thread or code block) into the input of another. In other words, each PipedInputStream is connected to a PipedOutputStream.

FIG. 8 is a block diagram illustrating a buffer object 706 for managing I/O streams in order to support the acquiring and sharing of runtime statistics in the system of FIG. 7 in accordance with various embodiments of the invention. As described above, the buffer object 706 includes aggregation code 802 that provides the appropriate data from the executing application to the appropriate probe(s) requesting data from the application (e.g., attempting to call the application). This is accomplished in various embodiments through the mapping of the input stream(s) to the output stream(s). In this manner, the data is piped from the application to the requesting probe(s).

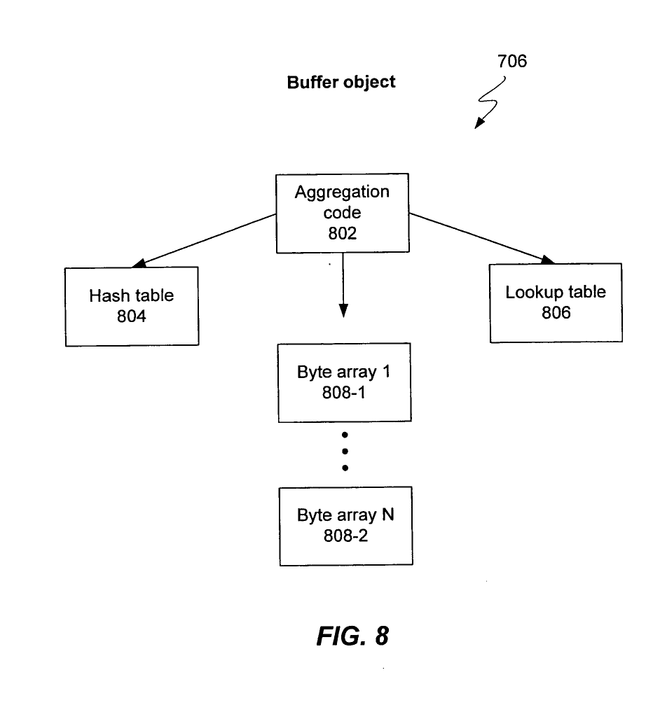

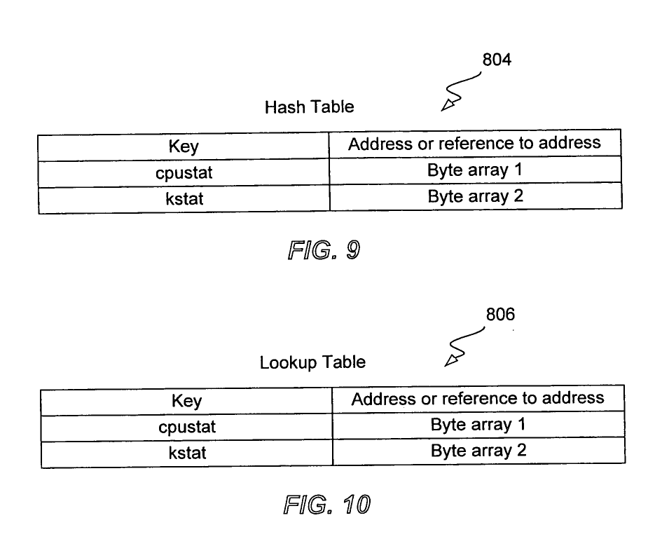

In order to map the input stream(s) to the output stream(s), a hash table 804 and lookup table 806 are implemented. The hash table 804 tracks the output streams, while the lookup table tracks the input streams 806. As described above with reference to the example of FIG. 7, two output streams collect the data which is delivered to four different probes that are gathering the data via an input stream. An exemplary hash table 804 and lookup table 806 will be described in further detail below with reference to FIG. 9 and FIG. 10, respectively.

When data is obtained, it is stored in one or more byte arrays 808-1 and 808-2. For instance, each byte array may correspond to a different output stream or probe. Historical data (e.g., data previously obtained and transmitted to the probe(s)) may be successively stored to disk as new data is stored in the byte arrays.

FIG. 9 is a diagram illustrating an exemplary hash table 804 as shown in FIG. 8 used to manage output streams in accordance with various embodiments of the invention. Specifically, for each output stream, an entry is maintained in the hash table 804. As shown, for each output stream, the entry includes a key identifying the instance of the application being executed and an address or reference to an address storing data generated by the instance of the application. For example, the key cpustat corresponding to an instance of the application cpustat corresponds to byte array 1, while the key kstat corresponding to an instance of the application kstat corresponds to byte array 2. In this manner, it is possible to store data for the appropriate application or instance and track the data for the application or instance.

FIG. 10 is a diagram illustrating an exemplary lookup table 806 as shown in FIG. 8 used to manage input streams in accordance with various embodiments of the invention. Specifically, for each input stream, an entry is maintained in the lookup table 806. As shown, for each input stream, the entry includes a key identifying the instance of the application being executed and an address or reference to an address storing data generated by the instance of the application. For example, the key cpustat corresponding to an instance of the application cpustat corresponds to byte array 1, while the key kstat corresponding to an instance of the application kstat corresponds to byte array 2. In this manner, it is possible to retrieve data for the appropriate application or instance. Moreover, through the use of the lookup table together with the hash table, an output stream may be piped through multiple input streams.

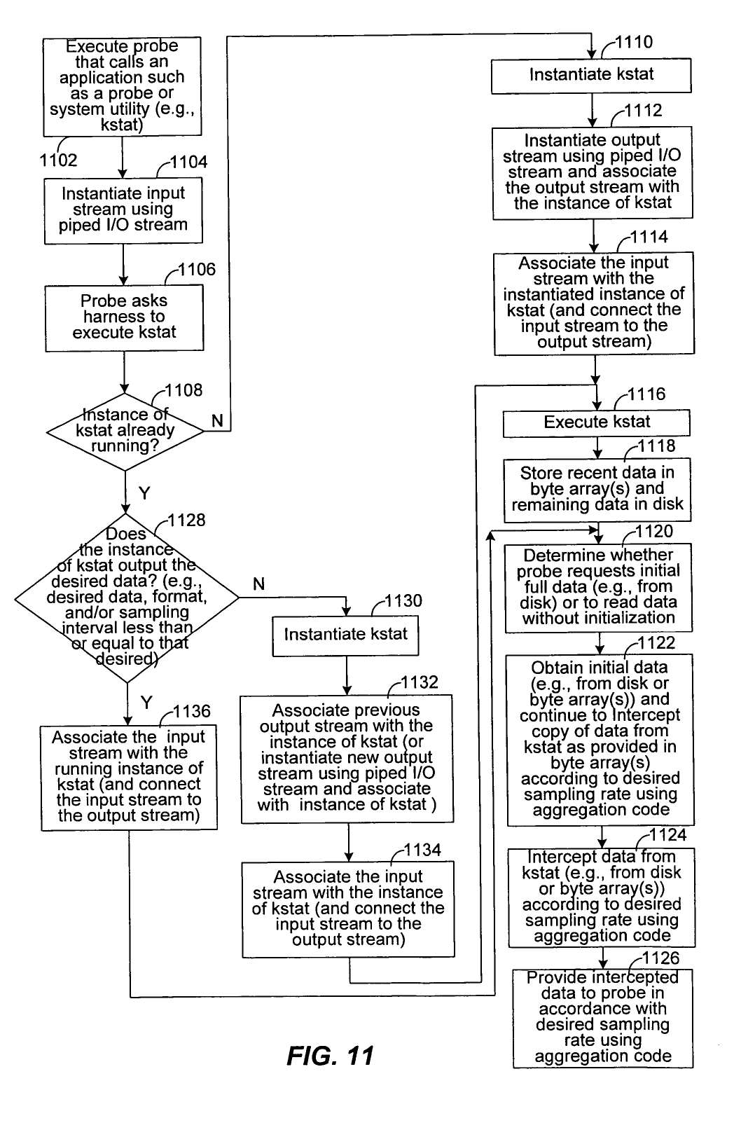

FIG. 11 is a process flow diagram illustrating a method of acquiring and sharing runtime statistics in accordance with various embodiments of the invention. As shown at block 1102, a probe that calls an application such as a probe or system utility (e.g., kstat) is executed. An input stream (e.g., PipedInputStream) is then instantiated at block 1104. The probe then requests that the user interface (i.e., harness) execute the application at block 1106. It is then determined whether the application (e.g., instance of the application) is executing at 1108.

If the application is not executing, the application is executed such that data provided by the application can be provided to multiple probes. Specifically, the application is instantiated at block 1110. An output stream (e.g., PipedOutputStream) is then instantiated and associated with the instance of the application at block 1112. For instance, an entry may be entered into a hash table such as that described above with reference to FIG. 9. The input stream is also associated with the appropriate probe and an instance of the application at block 1114. For instance, an entry may be entered into a lookup table such as that described above with reference to FIG. 10. In this manner, the input stream is connected to the output stream.

The instance of the application is then executed at block 1116. The data generated by the instance of the application is then stored at block 1118. The address(es) or reference to the appropriate address(es) at which the data is stored may then be stored in the appropriate entry in the hash and lookup tables as described above with reference to FIG. 10 and FIG. 11. In addition, each probe when it starts up may request the full data generated by an instance or to continue to receive or read data without such initialization at block 1120. Thus, if the probe has requested the full data, the historical data stored in the disk and/or byte array(s) is obtained provided to the probe at block 1122. In addition, the most current data stored in the byte array(s) continues to be obtained and provided to the probe. The data is preferably obtained and provided to the probe according to the desired sampling rate using a set of aggregation code as described above. Otherwise, the process continues at block 1124 to intercept and obtain the data (e.g., from the byte array(s)), which is preferably sampled according to the desired sampling rate. The data may therefore be provided to the probe in accordance with the desired sampling rate at block 1126.

It may be determined at block 1108 that the application (e.g., instance of the application) is already executing. In other words, two or more probes call the application or request data from the application. When it is ascertained that the application is executing, data produced by the application is provided to this additional probe if data provided by the application can be shared by the requesting probes. In other words, at block 1128, it is determined whether the instance of the application that is executing produces the desired data. For instance, the format of the data may be checked against that requested. In addition, the sampling interval of the executing application is preferably less than or equal to that desired (e.g., requested by the probe). In other words, the rate at which data is provided by the application is greater than or equal to that desired.

If data provided by the executing application cannot be shared by the probes, the application is executed such that data provided by the application can be provided to the probes and the data produced by the application is distributed to the probes (e.g., by the aggregation code). For instance, the application is executed such that the sampling rate or rate at which data is provided is greater than or equal to that of data requested by the probes. Specifically, the application is instantiated at block 1130 with the desired sampling rate. The previous output stream is preferably associated with the instance of the application (e.g., kstat) at block 1132, thereby replacing the old instance with the new instance. Thus, if a new probe requests data from the same underlying system utility that is already executing, that system utility may be restarted with the new “least common denominator.” Alternatively, a new output stream may be instantiated as described above and associated with the new instance of the application. For instance, a new key associated with the new instance of the application may be stored in the hash table as described above with reference to FIG. 9. In addition, the input stream is also associated with the new instance of the application at block 1134. For instance, a new key associated with the new instance of the application may be stored in the lookup table as described above with reference to FIG. 10. The process continues at block 1116 to execute the newly instantiated application and distribute data to the probe(s). In this manner, data produced by an application is distributed to multiple probes that call the application or request data from the application.

If data provided by the executing application can be shared by the probes, the input stream associated with the new probe (e.g., newly executing probe) is associated with the executing instance of the application (e.g., kstat) at block 1136. For instance, the appropriate key and memory location may be stored in a lookup table as described above with reference to FIG. 10. In this manner, the input stream may be connected to the output stream. The process continues at block 1120 to distribute data from the executing application to the probes that call the application or request data from the application.

As described above, the aggregation code provides data produced by the application to two or more probes. For instance, the aggregation code determines a sampling rate or rate at which data is requested by each of the two or more probes. Data produced by the application is then provided to each of the two or more probes at the sampling rate or rate at which data is requested by the corresponding one of the two or probes. As one example, the data may be sampled at the highest rate required by the probes. In other words, the data is sampled at the smallest time interval. The data may then be stored as well as distributed to those probes requesting a higher sampling rate (i.e., smaller sampling interval).

The probes requesting data (e.g., runtime statistics) from the same application may be executed simultaneously. However, execution of the probes may not be initiated simultaneously. In other words, they may request data from the application at different times. As a result, one or more instances of the application may be instantiated as necessary at different times. Accordingly, initiation of execution of the instances of the application need not be performed simultaneously.

Typically, runtime data is generated through the sampling of data and averaging of the sampled data. As a result, the accuracy of the runtime data that is generated depends upon the sampling rate and the time periods during which the data is sampled. However, the underlying hardware may limit the number of processes that may execute simultaneously. Thus, methods and apparatus for alternating multiple processes to obtain the desired data are disclosed. Moreover, the degree of accuracy of the data obtained by a single process (as well as multiple processes) may be increased.

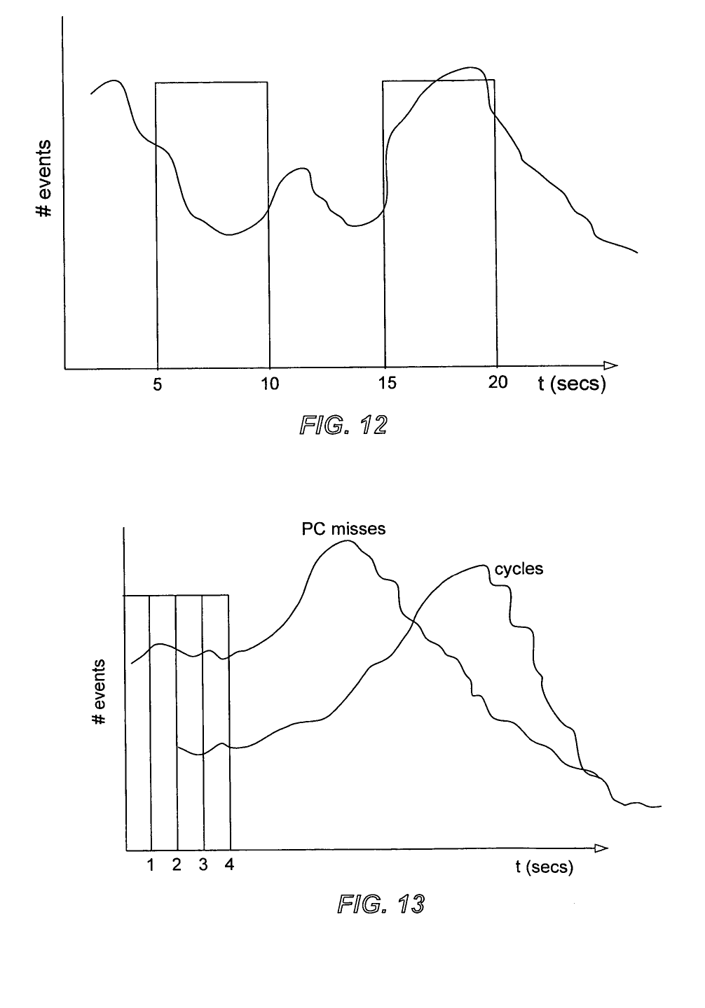

FIG. 12 is a diagram illustrating runtime data sampled in accordance with prior art methods. Since the number of hardware registers or other hardware may be limited, it may be impossible to execute two or more processes simultaneously that require this hardware in order to perform various computations. As a result, these processes are typically run sequentially.

As shown in FIG. 12, the time during which data is sampled is shown along the x-axis and the number of events are represented along the y-axis. If a particular application calculates the number of cycles per instruction (CPI), the first hardware register will be used to store the Cycle_Cnt, while the second hardware register will be used to store the instruction count. If another second application calculates different runtime statistics (e.g., TLB Misses), this second application typically cannot execute until the hardware registers are available. This means that the first application must traditionally complete its execution in order for the second application to execute. As a result, the first application executes for a period of time (e.g., 5 seconds), as specified by the user. In this example, the first application executes from time 0-5 seconds. The second application may then execute for a period of time (e.g., 5 seconds), as specified by the user. As shown, the second application executes from time 5-10 seconds. Thus, the first application is executed from 0-5 seconds and 10-15 seconds, while the second application is executed from 5-10 seconds and 15-20 seconds. As a result, each application misses data during alternating 5 second periods of time. Accordingly, the accuracy of the data obtained by each process is limited by the data that is not obtained during those periods of time. Moreover, the accuracy of the data diminishes as we begin to calculate more and more performance data (e.g., from the same probe).

FIG. 13 is a diagram illustrating runtime data sampled in accordance with various embodiments of the invention. In accordance with various embodiments of the invention, two different applications are alternated during the total specified time during which data is requested to be sampled. In addition, the sampling rate is increased for both applications and the sampling of data by the two applications is alternated during the total specified time. For instance, if the total time is 10 seconds, the sampling rate is increased for both applications and the sampling may be alternated every 1 second, as shown. In other words, the first application samples data for 1 second, then the second application samples data for 1 second, and so on. As a result, the accuracy of the data obtained as well as the resulting statistical average is increased.

Each of the applications may be a probe or system utility, as described above. For instance, the system utility may be an operating system utility and/or a statistics gathering utility.

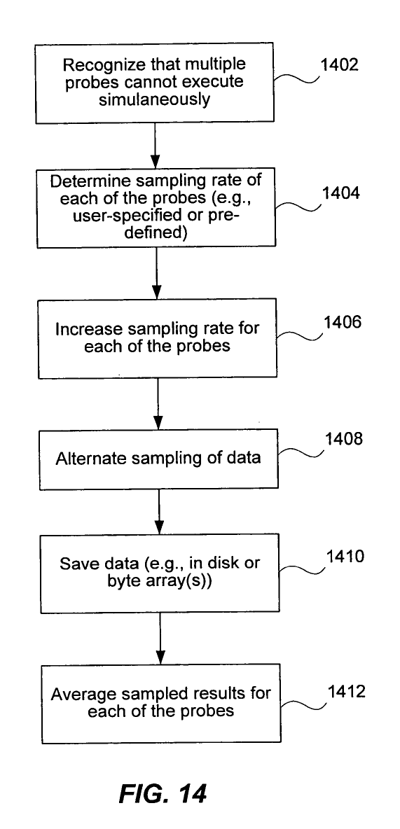

FIG. 14 is a process flow diagram illustrating a method of sampling data to enhance statistical performance in accordance with various embodiments of the invention. As shown at block 1402, it is first determined that the two or more applications (e.g., probes) cannot execute simultaneously, wherein each of the applications samples data. A sampling rate of each of the probes is then determined at block 1404. For instance, the sampling rate may be user-specified or predefined. In order to ascertain the sampling rate, the sampling time interval may be obtained. In addition, the total number of samples requested for each of the applications may be obtained. Moreover, the total period of time for a particular application may be obtained by multiplying the sampling time interval by the total number of samples requested.

The sampling rate for each of the two or more applications is then increased at block 1406. In order to increase the sampling rate, the total number of samples to be obtained may be increased. In addition, the sampling time interval may be reduced. The sampling rate need not be identical for the applications. However, the increased sampling rate may correspond to the number of columns of data that are generated. For instance, the sampling rate may be divided by two for two columns of data, divided by three for three columns, etc. The sampling time interval will therefore be reduced (e.g., from 5 to 1 second), and will preferably be the same for all of the applications.

The sampling of data by the two or more applications is then alternated at block 1408 at the increased sampling rate over a period of time. For instance, the period of time that sampling has been requested may be multiplied by the number of applications to ascertain a total sampling time for all of the applications. This total sampling time may then be divided into time intervals over which sampling of data will be alternated among the applications.

Each of the applications (e.g., probes) may sample data from a different data source as well as the same data source. For instance, the applications may sample data stored in hardware registers. As another example, data generated by other applications may be sampled.

After or during the sampling of data, the data that is sampled by the two or more applications is stored as shown at block 1410. For instance, the data may be stored to disk and/or to temporary storage (e.g., byte array(s)) as described above. The data that is sampled by each of the applications may then be averaged at block 1412 such that an average sampled value is obtained for each of the applications.

In accordance with one embodiment, a wrapper such as a Java™ wrapper is generated for one or more of the applications at the increased sampling rate. Each Java wrapper executes one or more of the applications over non-sequential segments of time during the period of time at the increased sampling rate. In other words, the non-sequential segments of time are smaller time intervals than that specified by any one of the applications. In addition, the Java wrapper may average the data that is sampled by the one or more of the applications such that an average sampled value is obtained for each of the one or more of the applications.

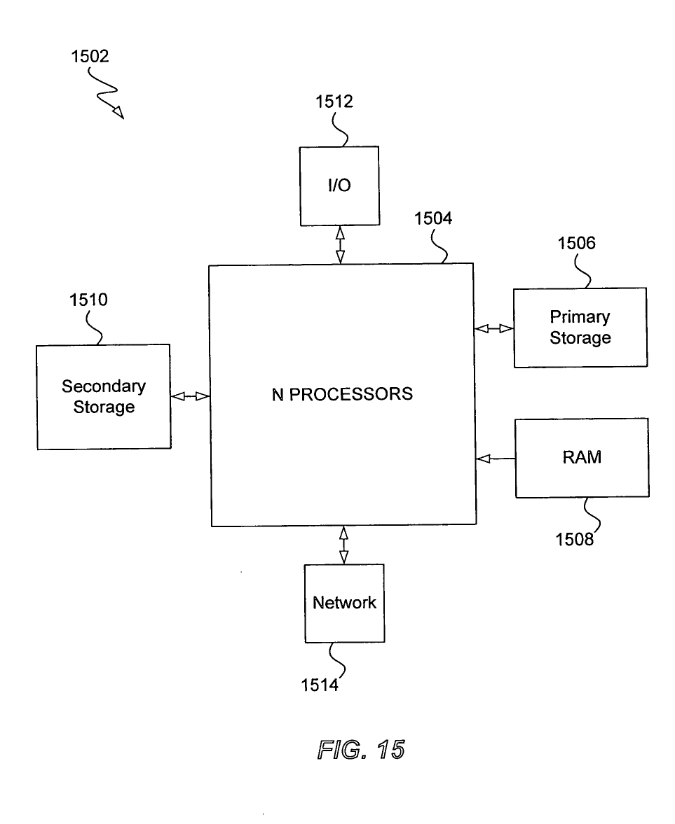

The present invention may be implemented on any suitable computer system. FIG. 15 illustrates a typical, general-purpose computer system 1502 suitable for implementing the present invention. The computer system may take any suitable form.

Computer system 1530 or, more specifically, CPUs 1532, may be arranged to support a virtual machine, as will be appreciated by those skilled in the art. The computer system 1502 includes any number of processors 1504 (also referred to as central processing units, or CPUs) that may be coupled to memory devices including primary storage device 1506 (typically a read only memory, or ROM) and primary storage device 1508 (typically a random access memory, or RAM). As is well known in the art, ROM acts to transfer data and instructions uni-directionally to the CPUs 1504, while RAM is used typically to transfer data and instructions in a bi-directional manner. Both the primary storage devices 1506, 1508 may include any suitable computer-readable media. The CPUs 1504 may generally include any number of processors.

A secondary storage medium 1510, which is typically a mass memory device, may also be coupled bi-directionally to CPUs 1504 and provides additional data storage capacity. The mass memory device 1510 is a computer-readable medium that may be used to store programs including computer code, data, and the like. Typically, the mass memory device 1510 is a storage medium such as a hard disk which is generally slower than primary storage devices 1506, 1508.

The CPUs 1504 may also be coupled to one or more input/output devices 1512 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPUs 1504 optionally may be coupled to a computer or telecommunications network, e.g., an internet network or an intranet network, using a network connection as shown generally at 1514. With such a network connection, it is contemplated that the CPUs 1504 might receive information from the network, or might output information to the network in the course of performing the above-described method steps. Such information, which is often represented as a sequence of instructions to be executed using the CPUs 1504, may be received from and outputted to the network, for example, in the form of a computer data signal embodied in a carrier wave.

Although illustrative embodiments and applications of this invention are shown and described herein, many variations and modifications are possible which remain within the concept, scope, and spirit of the invention, and these variations would become clear to those of ordinary skill in the art after perusal of this application. However, the present invention may be implemented in a variety of ways. Moreover, the above described process blocks are illustrative only. Therefore, the implementation may be performed using alternate process blocks as well as alternate data structures. Moreover, it may be desirable to use additional servers, such as a HTTP web server, in order to perform various processes (e.g., setup).

Accordingly, the present embodiments are to be considered as illustrative and not restrictive, and the invention is not to be limited to the details given herein, but may be modified within the scope and equivalents of the appended claims.

1. A method of sharing data provided by a first application to two or more additional applications, comprising:
ascertaining whether the first application is executing;
when it is ascertained that the first application is executing, providing data produced by the first application to the two or more additional applications if data provided by the first application can be shared by the two or more additional applications; and
when it is ascertained that the first application is not executing or if data provided by the executing first application cannot be shared by the two or more additional applications, executing the first application such that data provided by the first application can be provided to the two or more additional applications and distributing the data produced by the first application to the two or more additional applications.

2. The method as recited in claim 1, further comprising:
determining that the two or more additional applications call the first application.

3. The method as recited in claim 2, wherein determining that the two or more additional applications call the first application comprises:
receiving a request to execute the first application from the two or more additional applications.

4. The method as recited in claim 1, wherein ascertaining whether the first application is executing comprises:
ascertaining whether an instance of the first application is already running.

5. The method as recited in claim 1, wherein providing data produced by the first application to the two or more additional applications comprises:
determining a sampling rate requested by each of the two or more additional applications; and
providing the data produced by the first application to each of the two or more additional applications at the sampling rate requested by the corresponding one of the two or more additional applications.

6. The method as recited in claim 1, wherein providing data produced by the first application to the two or more additional applications comprises:
determining a rate at which data is requested by each of the two or more additional applications; and
providing the data produced by the first application to each of the two or more additional applications at the rate at which data is requested by the corresponding one of the two or more additional applications

7. The method as recited in claim 1, wherein providing data produced by the first application to the two or more additional applications comprises:
determining whether data provided by the first application can be shared by the two or more additional applications.

8. The method as recited in claim 7, wherein determining whether data provided by the first application can be shared by the two or more additional applications comprises:
ascertaining that a sampling rate of data sampled by the first application is greater than or equal to the sampling rate requested by the two or more additional applications.

9. The method as recited in claim 7, wherein determining whether data provided by the first application can be shared by the two or more additional applications comprises:
ascertaining that a rate at which data provided by the first application is greater than or equal to the rate at which data is requested by the two or more additional applications.

10. The method as recited in claim 1, wherein executing the first application such that data provided by the first application can be provided to the two or more additional applications comprises:
executing the first application such that a sampling rate of data sampled by the first application is greater than or equal to the sampling rate requested by the two or more additional applications.

11. The method as recited in claim 10, wherein executing the first application such that a sampling rate of data sampled by the first application is less than or equal to the sampling rate requested by the two or more additional applications comprises:
instantiating the first application with a sampling rate that is greater than or equal to the sampling rate requested by the two or more additional applications.

12. The method as recited in claim 1, wherein executing the first application such that data provided by the first application can be provided to the two or more additional applications comprises:
executing the first application such that a rate at which data provided by the first application is greater than or equal to the rate at which data is requested by the two or more additional applications.

13. The method as recited in claim 12, wherein executing the first application such that a rate at which data provided by the first application is greater than or equal to the rate at which data is requested by the two or more additional applications comprises:
instantiating the first application with a data rate that is greater than or equal to the rate at which data is requested by the two or more additional applications.

14. The method as recited in claim 1, wherein executing the first application such that data provided by the first application can be provided to the two or more additional applications comprises:
instantiating the first application.

15. The method as recited in claim 14, wherein instantiating the first application is performed when at least one of the two or more additional applications calls the first application.

16. The method as recited in claim 14, further comprising:
instantiating an instance of a PipedInputStream class of a java.io package to produce an input stream;
associating the input stream with one of the two or more additional applications; and
repeating the instantiating and associating steps for each of the two or more additional applications such that a separate PipedInputStream is associated with each of the two or more additional applications.

17. The method as recited in claim 16, further comprising:
instantiating an instance of a PipedOutputStream class of a java.io package to produce an output stream;
associating the output stream with an instance of the first application; and
repeating the instantiating and associating steps for each instance of the first application such that a separate PipedOutputStream is associated with each instance of the first application.

18. The method as recited in claim 17, further comprising:
connecting each PipedOutputStream to a PipedInputStream.

19. The method as recited in claim 1, wherein distributing the data produced by the first application to the two or more additional applications comprises:
determining a sampling rate requested by each of the two or more additional applications; and
providing the data produced by the first application to each of the two or more additional applications at the sampling rate requested by the corresponding one of the two or more additional applications.

20. The method as recited in claim 1, wherein distributing the data produced by the first application to the two or more additional applications comprises:
determining a rate at which data is requested by each of the two or more additional applications; and
providing the data produced by the first application to each of the two or more additional applications at the rate at which data is requested by the corresponding one of the two or more additional applications.

21. The method as recited in claim 1, wherein the first application is a system utility.

22. A method of sharing data provided by a first application to two or more additional applications, comprising:
determining that the two or more additional applications call the first application;
instantiating one or more instances of the first application, each of the instances of the first application sampling data at a different sampling rate;
executing each of the instances of the first application; and
providing data produced by the instances of the first application to the two or more additional applications such that the sampling rate of an instance of the first application is greater than or equal to a sampling rate requested by the corresponding one of the two or more additional applications that is receiving data from the instance of the first application.

23. The method as recited in claim 22, wherein instantiating the one or more instances of the first application is not performed simultaneously for the instances of the first application.

24. The method as recited in claim 22, wherein executing each of the instances of the first application is not initiated simultaneously for the instances of the first application.

25. The method as recited in claim 22, wherein determining that the two or more additional applications call the first application comprises:
when one of the two or more additional applications is executed, determining that the one of the additional applications calls the first application.

26. The method as recited in claim 22, further comprising:
when one of the two or more additional applications is executed, determining a sampling rate requested by the one of the two or more additional applications;
determining whether an instance of the first application that is executing has a sampling rate that is greater than or equal to the sampling rate requested by the one of the two or more additional applications;
when it is determined that an instance of the first application that is executing has a sampling rate that is greater than or equal to the sampling rate requested by the one or the two or more additional applications, providing data from the instance of the first application to the one of the two or more additional applications; and
when it is determined that an instance of the first application that is executing does not have a sampling rate that is greater than or equal to the sampling rate requested by the one of the two or more additional applications, instantiating a new instance of the first application with a sampling rate that is greater than or equal to the sampling rate requested by the one of the two or more additional applications and providing data from the new instance of the first application to the one of the two or more additional applications.

27. A method of sharing data provided by a first application to two or more additional applications, comprising:
when one of the two or more additional applications is executed, determining a sampling rate requested by the one of the two or more additional applications;
determining whether an instance of the first application that is executing has a sampling rate that is greater than or equal to the sampling rate requested by the one of the two or more additional applications;
when it is determined that an instance of the first application that is executing has a sampling rate that is greater than or equal to the sampling rate requested by the one or the two or more additional applications, providing data from the instance of the first application to the one of the two or more additional applications; and
when it is determined that an instance of the first application that is executing does not have a sampling rate that is greater than or equal to the sampling rate requested by the one of the two or more additional applications, instantiating a new instance of the first application with a sampling rate that is greater than or equal to the sampling rate requested by the one of the two or more additional applications and providing data from the new instance of the first application to the one of the two or more additional applications.

28. A computer-readable medium storing thereon computer-readable instructions for sharing data provided by a first application to two or more additional applications, comprising:
instructions for determining a sampling rate requested by the one of the two or more additional applications when one of the two or more additional applications is executed;
instructions for determining whether an instance of the first application that is executing has a sampling rate that is greater than or equal to the sampling rate requested by the one of the two or more additional applications;
instructions for providing data from the instance of the first application to the one of the two or more additional applications when it is determined that an instance of the first application that is executing has a sampling rate that is greater than or equal to the sampling rate requested by the one or the two or more additional applications; and
instructions for instantiating a new instance of the first application with a sampling rate that is greater than or equal to the sampling rate requested by the one of the two or more additional applications and providing data from the new instance of the first application to the one of the two or more additional applications when it is determined that an instance of the first application that is executing does not have a sampling rate that is greater than or equal to the sampling rate requested by the one of the two or more additional applications.

29. An apparatus for sharing data provided by a first application to two or more additional applications, comprising:
means for when one of the two or more additional applications is executed, determining a sampling rate requested by the one of the two or more additional applications;
means for determining whether an instance of the first application that is executing has a sampling rate that is greater than or equal to the sampling rate requested by the one of the two or more additional applications;
means for when it is determined that an instance of the first application that is executing has a sampling rate that is greater than or equal to the sampling rate requested by the one or the two or more additional applications, providing data from the instance of the first application to the one of the two or more additional applications; and
means for when it is determined that an instance of the first application that is executing does not have a sampling rate that is greater than or equal to the sampling rate requested by the one of the two or more additional applications, instantiating a new instance of the first application with a sampling rate that is greater than or equal to the sampling rate requested by the one of the two or more additional applications and providing data from the new instance of the first application to the one of the two or more additional applications.

30. An apparatus for sharing data provided by a first application to two or more additional applications, comprising:
a processor; and
a memory, at least one of the processor and the memory being adapted for:
when one of the two or more additional applications is executed, determining a sampling rate requested by the one of the two or more additional applications;
determining whether an instance of the first application that is executing has a sampling rate that is greater than or equal to the sampling rate requested by the one of the two or more additional applications;
when it is determined that an instance of the first application that is executing has a sampling rate that is greater than or equal to the sampling rate requested by the one or the two or more additional applications, providing data from the instance of the first application to the one of the two or more additional applications; and
when it is determined that an instance of the first application that is executing does not have a sampling rate that is greater than or equal to the sampling rate requested by the one of the two or more additional applications, instantiating a new instance of the first application with a sampling rate that is greater than or equal to the sampling rate requested by the one of the two or more additional applications and providing data from the new instance of the first application to the one of the two or more additional applications.

31. A computer-readable medium storing thereon computer-readable instructions for sharing data provided by a first application to two or more additional applications, comprising:
instructions for ascertaining whether the first application is executing;
instructions for providing data produced by the first application to the two or more additional applications if data provided by the first application can be shared by the two or more additional applications when it is ascertained that the first application is executing; and
instructions for executing the first application such that data provided by the first application can be provided to the two or more additional applications and distributing the data produced by the first application to the two or more additional applications when it is ascertained that the first application is not executing or if data provided by the executing first application cannot be shared by the two or more additional applications.

32. An apparatus for sharing data provided by a first application to two or more additional applications, comprising:
means for ascertaining whether the first application is executing;
means for providing data produced by the first application to the two or more additional applications if data provided by the first application can be shared by the two or more additional applications when it is ascertained that the first application is executing; and
means for executing the first application such that data provided by the first application can be provided to the two or more additional applications and distributing the data produced by the first application to the two or more additional applications when it is ascertained that the first application is not executing or if data provided by the executing first application cannot be shared by the two or more additional applications.

33. An apparatus for sharing data provided by a first application to two or more additional applications, comprising:
a processor; and
a memory, at least one of the processor and the memory being adapted for:
ascertaining whether the first application is executing;
providing data produced by the first application to the two or more additional applications if data provided by the first application can be shared by the two or more additional applications when it is ascertained that the first application is executing; and
executing the first application such that data provided by the first application can be provided to the two or more additional applications and distributing the data produced by the first application to the two or more additional applications when it is ascertained that the first application is not executing or if data provided by the executing first application cannot be shared by the two or more additional applications.
